(19) United States
(12) Patent Application Publication
(10) Pub. No.: US 2022/0303004 A1
(43) Pub. Date: Sep. 22, 2022

(54) WIRELESS COMMUNICATION SYSTEM, WIRELESS TERMINAL EQUIPMENT, WIRELESS BASE STATION EQUIPMENT AND WIRELESS COMMUNICATION METHODS

(71) Applicant: NIPPON TELEGRAPH AND TELEPHONE CORPORATION, Tokyo (JP)

(72) Inventors: Tomohiro TANIGUCHI, Musashino-shi, Tokyo, Tokyo (JP); Shinya TAMAKI, Musashino-shi, Tokyo (JP); Ryota SHIINA, Musashino-shi, Tokyo (JP); Kazutaka HARA, Musashino-shi, Tokyo (JP); Tomoki MURAKAMI, Musashino-shi, Tokyo (JP); Toshiro NAKAHIRA, Musashino-shi, Tokyo (JP)

(73) Assignee: NIPPON TELEGRAPH AND TELEPHONE CORPORATION, Tokyo (JP)

(21) Appl. No.: 17/632,901

(22) PCT Filed: Aug. 7, 2019
(86) PCT No.: PCT/JP2019/031260

§ 371 Date: Feb. 4, 2022

(51) Int. Cl. H04B 10/11

(52) U.S. Cl. CPC H04B 10/11

(57) ABSTRACT

According to the present disclosure, a wireless base station device delivers, to a wireless terminal device, an optical ID having a simple configuration in accordance with a pre-stored optical ID correspondence list; and the wireless terminal device selects connection authentication information corresponding to the received optical ID from a pre-stored optical ID correspondence list, and transmits predetermined authentication information to the wireless base station device through a predetermined connection method by RF wireless. Upon confirming that the received authentication information matches authentication information corresponding to an optical ID in the optical ID correspondence list, the wireless base station device permits information communication between the wireless terminal device and a higher-level network.

### TECHNICAL FIELD

The present disclosure relates to a wireless communication system, a wireless terminal device, a wireless base station device, and a wireless communication method for opening a RF (Radio Frequency) wireless channel between a base station device and a terminal device by using optical wireless for authentication.

### BACKGROUND ART

High-speed Internet service using FTTH (Fiber-To-The-Home), LTE (Long Term Evolution), or the like has become an indispensable tool in peoples' daily lives. Particularly, in recent years, the spread of cloud usage and the expansion of mobile terminal usage has led to a rapid spread of a wide variety of applications and services beyond mere IP data communication, such as IoT (Internet of Things)/M2M (Machine to Machine), 4K/8K high-definition video distribution services, online video distribution services, video uploading over SNS, and the like. Furthermore, new work styles such as telework using ICT are being proposed, and demand for services employing networks is expected to continue to grow. Currently, with the spread of FTTH, stable optical broadband services are being provided to homes, while in the home environment, wireless communication methods have become mainstream, due to the use of multiple devices other than PCs, the lack of a need for cable wiring, and the diversification of services as mentioned above.

Wireless communication systems can be broadly divided into two categories in terms of frequency domain, with 3 THz as a boundary. The frequency band below 3 THz is called the radio range, and includes cellular systems such as LTE and 5G, wireless LANs that use unlicensed bands, and the like.

On the other hand, the frequency band above 3 THz (below 30 PHz) is called the light wave range, and corresponds to systems that use infrared or visible light, as well as Li-Fi, which transmits and receives through high-speed modulation of LEDs, which are being used in lighting in recent years.

Wireless communication systems in the radio range and the light wave range have different characteristics depending on the frequency band used. For example, wireless communication systems in the light wave range have extremely high directivity, which results in a narrow coverage area. Wireless communication systems in the radio range have a wide coverage area due to the diffraction and transmission characteristics of radio waves. Because these wireless communication systems have paired coverage area characteristics, hybrid-type wireless communication systems using both the radio range and the light wave range, which complement each other's characteristics in terms of communication area limitations, communication safety, and communication stability, can be considered.

Proposals for such systems have already been made; for example, the invention of PTL 1 is a hybrid-type wireless communication system using visible light communication and Wi-Fi communication, which improves the convenience of Wi-Fi communication for end users and enables Wi-Fi communication only in specific areas. This document describes a method in which authentication information for accessing a network, such as an SSID (Service Set IDentifier), a password/PMK (Pairwise Master Key), a BSSID (Basuic SSID), an ESSID (Extended SSID), a channel, and the like, is sent from the wireless base station device to a wireless terminal device through visible light communication, the authentication information is received by a photodetector provided in the wireless terminal device, and on the basis of the received authentication information, an authentication server performs authentication and establishes communication through Wi-Fi communication between the wireless base station device and the wireless terminal device.

### CITATION LIST

### Patent Literature

[PTL 1] US 2018/0139202 A1

### Non Patent Literature

[NPL 1] Tomoaki Shikakura et al., “A Study on Perception of Brightness Variation in an Office Proof Environment,” Journal of the Illuminating Engineering Institute of Japan, Vol. 85, No. 5, 2001, pp. 346-351

### SUMMARY OF THE INVENTION

### Technical Problem

In PTL 1, a visible light source provided in a wireless base station device transmits authentication information such as an SSID and a password through an optical modulated signal. Two methods can be given as optical modulation for transmitting authentication information such as an SSID and a password, namely current-driven direct modulation of electrical signals, which are the authentication information, using a driver circuit for modulation, and modulation by changing a physical quantity (intensity, phase, or the like) of light using an optical device called an external modulator. Both of these systems increase costs by an amount corresponding to the modulation circuit and the external modulator, and therefore cannot be said to be economical. The system also requires wireless terminal devices to have demodulator circuits to demodulate received optical modulated signals, and therefore cannot be said to be economical.

Accordingly, to solve the aforementioned problems, an object of the present disclosure is to provide an RF/optical hybrid-type wireless communication system in which RF wireless, which uses the radio range, and optical wireless, which uses the light wave range, complement each other's characteristics, so as to limit the communication area, ensure communication safety, and ensure communication stability. A further object of the present disclosure is to realize a wireless communication system including a wireless base station device, a wireless terminal device, and the like with a simple configuration.

### Means for Solving the Problem

The present disclosure solves the aforementioned problems by a wireless base station device delivering, to a wireless terminal device, an optical ID having a simple configuration in accordance with a pre-stored optical ID correspondence list; and the wireless terminal device selecting connection authentication information corresponding to the received optical ID from a pre-stored optical ID correspondence list, and transmitting predetermined authentication information to the wireless base station device through a predetermined connection method by RF wireless. Upon confirming that the received authentication information matches authentication information corresponding to an optical ID in the optical ID correspondence list, the wireless base station device permits information communication between the wireless terminal device and a higher-level network.

A wireless communication system according to the present disclosure includes a wireless base station device and a wireless terminal device that performs RF wireless communication with the wireless base station device using an optical signal from the wireless base station device for authentication. The wireless base station device includes: a base station-side optical ID correspondence list containing an optical ID along with combined information including connection information and authentication information of wireless communication corresponding to the optical ID; an optical signal control circuit that verifies the connection information and authentication information against the base station-side optical ID correspondence list, extracts a corresponding optical ID, and generates a signal pattern according to the extracted optical ID; an optical transmission circuit that outputs the optical signal according to the signal pattern from the optical signal control circuit; a beam controller that controls a beam shape of the optical signal from the optical transmission circuit and delivers the optical signal into a space; a base station-side RF receiver that receives authentication information from the wireless terminal device in predetermined RF wireless according to the connection information verified by the optical signal control circuit; and a connection authentication control circuit that confirms a match between the authentication information from the base station-side RF receiver and the authentication information verified by the optical signal control circuit, and permits information communication between a wireless terminal device having matching authentication information and a higher-level network. The wireless terminal device includes: an optical receiver that receives the optical signal from the beam controller and converts the optical signal into a signal pattern; a terminal-side optical ID list containing an optical ID along with combined information including connection information and authentication information of wireless communication corresponding to the optical ID; an optical ID analysis circuit that regenerates an optical ID from the signal pattern from the optical receiver, verifies the optical ID against the terminal-side optical ID correspondence list, and extracts corresponding connection information and authentication information; and a terminal-side RF transmitter that transmits the authentication information from the optical ID analysis circuit in predetermined RF wireless according to the connection information from the optical ID analysis circuit.

A wireless communication method according to the present disclosure is a wireless communication method for performing RF wireless communication between a wireless base station device and a wireless terminal device using an optical signal from the wireless base station device to the wireless terminal device for authentication. The method includes the wireless base station device: verifying connection information and authentication information against a base station-side optical ID correspondence list containing an optical ID along with combined information including connection information and authentication information of wireless communication corresponding to the optical ID, extracting a corresponding optical ID, and generating a signal pattern according to the extracted optical ID; outputting an optical signal according to the generated signal pattern; and controlling a beam shape of the output optical signal and delivering the optical signal into a space. The method further includes the wireless terminal device: receiving the optical signal from the wireless base station device and converting the optical signal into a signal pattern; regenerating an optical ID from the signal pattern that has been converted, verifying the optical ID against a terminal-side optical ID list containing an optical ID along with combined information including connection information and authentication information of wireless communication corresponding to the optical ID, and extracting corresponding connection information and authentication information; and transmitting the extracted authentication information in predetermined RF wireless according to the extracted connection information. The method further includes the wireless base station: receiving the authentication information from the wireless terminal device in predetermined RF wireless according to the verified connection information; and confirming a match between the received authentication information and the authentication information verified against the base station-side optical ID correspondence list, and permitting information communication between a wireless terminal device having matching authentication information and a higher-level network.

### Effects of the Invention

A wireless communication system, wireless base station device, wireless terminal device, and wireless communication method according to the present disclosure make it possible to limit a communication area, ensure communication safety, and ensure communication stability by using the characteristics of optical wireless and RF wireless, and furthermore a wireless base station device, a wireless terminal device, and the like with a simple configuration.

### BRIEF DESCRIPTION OF DRAWINGS

FIG. 1 illustrates an example of the configuration of a wireless communication system according to the present disclosure.

FIG. 2 illustrates an example of a base station-side optical ID correspondence list or a terminal-side optical ID correspondence list according to the present disclosure.

FIG. 3 illustrates an example of the characteristics of an optical signal output by an optical transmission circuit according to the present disclosure.

FIG. 4 illustrates an example of the characteristics of an optical signal output by an optical transmission circuit according to the present disclosure.

FIG. 5 illustrates an example of the characteristics of an optical signal output by an optical transmission circuit according to the present disclosure.

FIG. 6 illustrates an example of the characteristics of an optical signal output by an optical transmission circuit according to the present disclosure.

FIG. 7 illustrates an example of the configuration of a wireless communication system according to the present disclosure.

### DESCRIPTION OF EMBODIMENTS

Hereinafter, embodiments of the present disclosure will be described in detail with reference to the drawings. Note, however, that the present disclosure is not limited to the embodiments described below. These examples are merely illustrative, and the present disclosure can be implemented in various modified and improved forms on the basis of knowledge of one skilled in the art. In the present specification and the drawings, constituent elements having the same reference signs are assumed to indicate the same entities.

### First Embodiment

An example embodying the present disclosure will be described hereinafter.

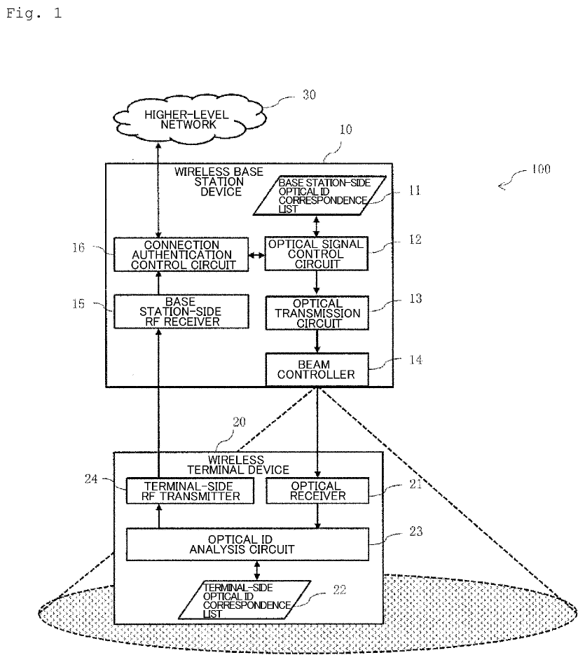

FIG. 1 illustrates an example of the configuration of a wireless communication system according to the present embodiment. A wireless communication system 100 according to the present embodiment includes a wireless base station device 10, and a wireless terminal device 20 that performs RF wireless communication with the wireless base station device 10 using an optical signal from the wireless base station device 10 for authentication.

The wireless base station device 10 includes: a base station-side optical ID correspondence list 11 containing an optical ID along with combined information including connection information and authentication information of wireless communication corresponding to the optical ID; an optical signal control circuit 12 that verifies the connection information and authentication information against the base station-side optical ID correspondence list 11, extracts a corresponding optical ID, and generates a signal pattern according to the extracted optical ID; an optical transmission circuit 13 that outputs the optical signal according to the signal pattern from the optical signal control circuit 12; a beam controller 14 that controls a beam shape of the optical signal from the optical transmission circuit 13 and delivers the optical signal into a space; a base station-side RF receiver 15 that receives authentication information from the wireless terminal device 20 in predetermined RF wireless according to the connection information verified by the optical signal control circuit 12; and a connection authentication control circuit 16 that confirms a match between the authentication information from the base station-side RF receiver 15 and the authentication information verified by the optical signal control circuit 12, and permits information communication between a wireless terminal device 20 having matching authentication information and a higher-level network 30.

The wireless terminal device 20 includes: an optical receiver 21 that receives the optical signal from the beam controller 14 and converts the optical signal into a signal pattern; a terminal-side optical ID list 22 containing an optical ID along with combined information including connection information and authentication information of wireless communication corresponding to the optical ID; an optical ID analysis circuit 23 that regenerates an optical ID from the signal pattern from the wireless base station device 10, verifies the optical ID against the terminal-side optical ID correspondence list 22, and extracts corresponding connection information and authentication information; and a terminal-side RF transmitter 24 that transmits the authentication information from the optical ID analysis circuit 23 in predetermined RF wireless according to the connection information from the optical ID analysis circuit 23.

In a wireless communication method according to the present embodiment, the wireless base station device 10: verifies connection information and authentication information against the base station-side optical ID correspondence list 11 containing an optical ID along with combined information including connection information and authentication information of wireless communication corresponding to the optical ID; extracts a corresponding optical ID; generates a signal pattern according to the extracted optical ID; outputs an optical signal according to the generated signal pattern; and controls a beam shape of the output optical signal and delivers the optical signal into a space.

Next, the wireless terminal device 20: receives the optical signal from the wireless base station device 10 and converts the optical signal into a signal pattern; regenerates an optical ID from the signal pattern that has been converted; verifies the optical ID against the terminal-side optical ID list 22 containing an optical ID along with combined information including connection information and authentication information of wireless communication corresponding to the optical ID; extracts corresponding connection information and authentication information; and transmits the extracted authentication information in predetermined RF wireless according to the extracted connection information.

Furthermore, the wireless base station device 10: receives the authentication information from the wireless terminal device 20 in predetermined RF wireless according to the verified connection information; confirms a match between the received authentication information and the authentication information verified against the base station-side optical ID correspondence list 11; and permits information communication between a wireless terminal device 20 having matching authentication information and the higher-level network.

Operations of the wireless communication system will be described hereinafter with reference to FIG. 1.

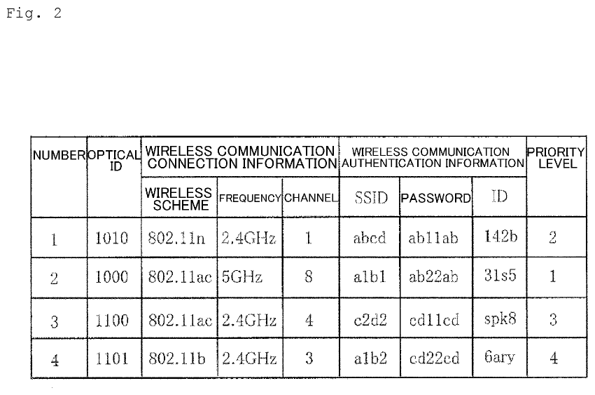

The base station-side optical ID list 11 contains an optical ID along with combined information including connection information and authentication information of wireless communication corresponding to the optical ID. FIG. 2 illustrates an example of the base station-side optical ID correspondence list 11. In FIG. 2, numbers 1 to 4 indicate four examples of the optical ID. The connection information of the wireless communication is information defining which wireless scheme, which frequency, and which channel to use for RF wireless communication between the wireless base station device 10 and the wireless terminal device 20. The authentication information of the wireless communication is information defining an SSID (Service Set Identifier), a password, and an ID (Identifier) used when the wireless terminal device 20 accesses the wireless base station device 10. Only one of these may be defined, or any desired plurality of these may be defined. The connection information of the wireless communication and the authentication information of the wireless communication are examples, and other necessary information may be defined as well.

The optical signal control circuit 12 verifies connection information and authentication information against the base station-side optical ID correspondence list 11 and extracts a corresponding optical ID. For example, when the connection information and the authentication information for number “1” is used, “1010” is extracted as the optical ID. A signal pattern according to the extracted optical ID is generated. Here, the signal pattern is “1010”, in accordance with the optical ID of “1010”. However, it is not absolutely necessary for the signal pattern to be “1010” in accordance with the optical ID of “1010”, and a signal pattern such as “101011” may be used, for example. If the signal pattern is analog, when the optical ID is “1010”, the signal pattern repeats at a frequency of 1 Hz, for example. When the optical ID is “1000”, the signal pattern repeats at a frequency of 2 Hz.

The optical transmission circuit 13 outputs the optical signal according to the signal pattern from the optical signal control circuit 12. When a holder of the wireless terminal device 20 enters the area of the wireless base station device 10, if the modulation of the optical signal delivered by the beam controller 14 is at a level not perceptible to humans, the optical signal will not cause discomfort to humans. According to NPL 1, it is desirable that the optical modulation level be no greater than 20%. At this level, light intensity fluctuations cannot be perceived in a situation where a human is concentrating on a given task. It is further desirable that the optical modulation level be no greater than 7%. At this level, light intensity fluctuations cannot be perceived regardless of a human's activity state.

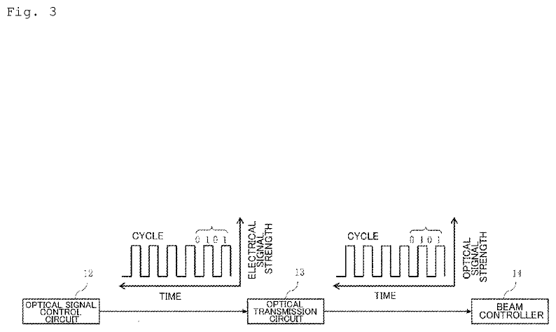

FIG. 3 to FIG. 6 illustrate examples of the signal pattern generated by the optical signal control circuit 12 and the optical signal output by the 13 of the optical transmission circuit. FIG. 3 is an example of the optical signal control circuit 12 generating a signal pattern of “1010”, which is a digital signal, and the optical transmission circuit 13 outputting an optical signal of “1010” as a digital signal. In this case, the optical signal output by the optical transmission circuit 13 and light from an illumination device different from the optical transmission circuit 13 merge, and the optical modulation level is set to no greater than a predetermined percentage for both lights.

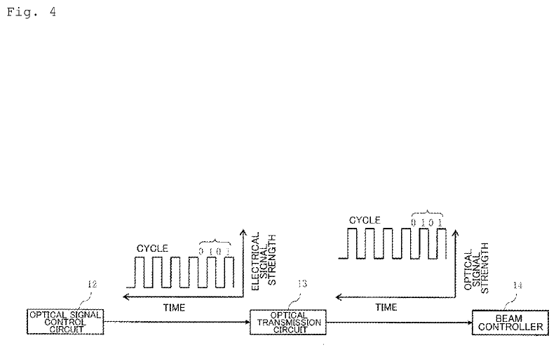

FIG. 4 is an example of the optical signal control circuit 12 generating a signal pattern of “1010”, which is an electrical signal, and the optical transmission circuit 13 outputting an optical signal of “1010” as a digital signal. The optical transmission circuit 13 includes bias light in the optical signal of “1010” itself, and sets the optical modulation level of the optical signal output by the optical transmission circuit 13 to no greater than a predetermined percentage. In this case, the optical transmission circuit 13 has dual functions of outputting the optical signal and outputting illumination.

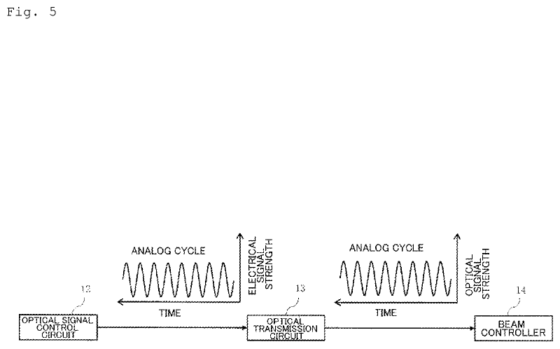

FIG. 5 is an example of the optical signal control circuit 12 generating a cyclical analog signal pattern, which is an electrical signal, and the optical transmission circuit 13 outputting a cyclical optical signal as an analog signal. In this case, the optical signal output by the optical transmission circuit 13 and light from an illumination device different from the optical transmission circuit 13 merge, and the optical modulation level is set to no greater than a predetermined percentage for both lights.

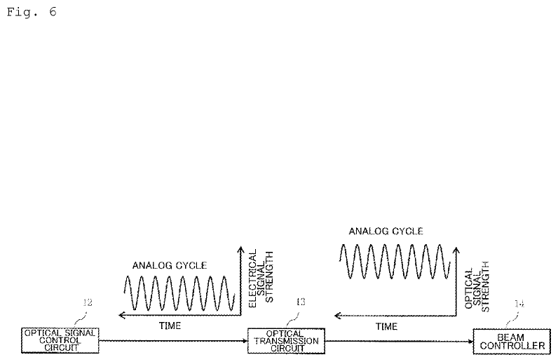

FIG. 6 is an example of the optical signal control circuit 12 generating a cyclical analog signal pattern, which is an electrical signal, and the optical transmission circuit 13 outputting a cyclical optical signal as an analog signal. In FIG. 6, the optical transmission circuit 13 includes bias light in the cyclical optical signal itself, and sets the optical modulation level of the optical signal output by the optical transmission circuit 13 to no greater than a predetermined percentage. In this case, the optical transmission circuit 13 has dual functions of outputting the optical signal and outputting illumination.

The optical transmission circuit 13 may be configured to perform frequency modulation or wavelength modulation instead of intensity modulation. In this case, the frequency or the wavelength of the optical signal from the optical transmission circuit is modulated according to the intensity of the signal pattern.

The optical beam controller 14 controls the beam shape of the optical signal from the optical transmission circuit 13, and delivers the optical signal into a space set for the wireless base station device 10. This is done to set the area in which the wireless communication system can communicate. The linearity of the light wave output can be used to limit the communication area and ensure the safety of communication. A reflector, a transparent refractive element, or the like can be used to control the beam shape.

The optical receiver 21 receives the optical signal from the beam controller 14 and converts the optical signal into a signal pattern of an electrical signal. A light-receiving element corresponding to the wavelength of the light emitted from the optical transmission circuit 13 may be selected to receive the light. The optical receiver 21 can receive the optical signal from the beam controller 14 only when the wireless terminal device 20 is within the area where communication is possible, set by the beam controller 14. Receiving optical signals does not require a high-speed demodulation circuit, a wireless terminal device having a simple configuration can be realized. The optical receiver 21 receives the optical signal, removes the bias component, and extracts the electrical signal pattern. When the optical signal is a digital signal of “1010”, the optical receiver 21 converts the optical signal into an electrical signal pattern of “1010”, for example. When the optical signal is an analog signal, the optical receiver 21 converts the signal into an electrical signal pattern with a repetition rate of 1 Hz, for example.

The terminal-side optical ID correspondence list 22 has the same content as the base station-side optical ID correspondence list 11. In other words, the terminal-side optical ID list 22 contains an optical ID along with combined information including connection information and authentication information of wireless communication corresponding to the optical ID. An example of the terminal-side optical ID correspondence list 11 is the same as in FIG. 2.

The optical ID analysis circuit 23 regenerates the optical ID from the signal pattern from the optical receiver 21, and verifies the optical ID against the terminal-side optical ID correspondence list 22. Next, the connection information and the authentication information corresponding to the optical ID are extracted. For example, the optical ID analysis circuit 23 regenerates the optical ID of “1010” from the signal pattern of “1010” from the optical receiver 21, and verifies the optical ID of “1010” against the terminal-side optical ID correspondence list 22. For example, the optical ID analysis circuit 23 regenerates the optical ID of “1010” from the signal pattern having a repetition rate of 1 Hz from the optical receiver 21, and verifies the optical ID of “1010” against the terminal-side optical ID correspondence list 22. The optical ID analysis circuit 23 extracts the connection information and the authentication information for the number “1”, which corresponds to the optical ID of “1010”. When verifying the regenerated optical ID against the terminal-side optical ID correspondence list 22, the optical ID analysis circuit 23 may detect an optical ID that is a perfect match, or may detect an optical ID having a maximum correlation coefficient. If the wireless terminal device 20 is present in the areas of a plurality of wireless base station devices 10, the wireless terminal device 20 receives an optical signal from each of the plurality of wireless base station devices 10 and regenerates a plurality of optical IDs. In this case, a priority level of the plurality of numbers is extracted from the terminal-side optical ID correspondence list 22, and the connection information and authentication information of the number having the highest priority level is extracted.

The terminal-side RF transmitter 24 sets an RF wireless standard, such as a predetermined wireless scheme, frequency, channel, and the like, in accordance with the connection information extracted by the optical ID analysis circuit 23. Next, the terminal-side RF transmitter 24 transmits the authentication information extracted by the optical ID analysis circuit 23 to the wireless base station device 10 using the set RF wireless. Using the diffuse nature of radio waves for the transmission of the authentication information and the information communication after authentication makes it possible to ensure the stability of the communication.

The base station-side RF receiver 15 sets a predetermined RF wireless standard in accordance with the connection information verified by the optical signal control circuit 12. Next, the base station-side RF receiver 15 receives the authentication information from the terminal-side RF transmitter 24 through RF wireless, and outputs the authentication information to the connection authentication control circuit 16.

The connection authentication control circuit 16 confirms whether the authentication information from the base station-side RF receiver 13 and the authentication information verified by the optical signal control circuit 12 match. When the two pieces of authentication information match, the connection authentication control circuit 16 permits the information communication between the wireless terminal device 20 and the higher-level network 30. Using an RF/optical wireless hybrid-type wireless communication system makes it possible to ensure the safety of communication. The wireless terminal device 20 may further include a terminal-side RF receiver, and the wireless base station device 10 a base station-side RF transmitter, for information communication following the authentication.

It is desirable that the optical ID analysis circuit 23 perform the operations for analyzing the optical ID at the start of information communication. This is to ensure the safety of communication. This also makes it possible to perform stable information communication through RF wireless between the wireless base station device 10 and the wireless terminal device 20 even if the optical wireless is cut off after the analysis operations. The optical ID analysis circuit 23 may perform the determination operations periodically or continually. It is easy to ensure the safety of communication by blocking information communication when the wireless terminal device 20 moves outside the beam from the beam controller 14. The optical ID analysis circuit 23 may perform the determination operations within a pre-set timeslot, e.g., for only ten seconds. Limiting the time makes it easy to ensure the safety of communication.

A wireless communication system, wireless base station device, wireless terminal device, and wireless communication method according to the present embodiment make it possible to limit a communication area, ensure communication safety, and ensure communication stability by using the characteristics of optical wireless and RF wireless, and furthermore a wireless base station device, a wireless terminal device, and the like with a simple configuration.

### Second Embodiment

An example embodying the present disclosure is shown below.

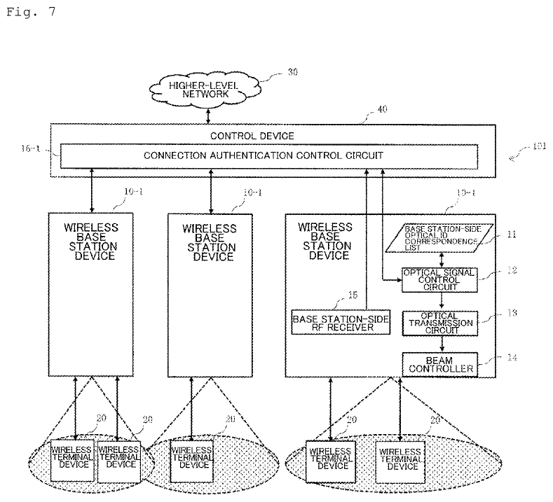

FIG. 7 illustrates an example of the configuration of a wireless communication system according to the present embodiment. A wireless communication system 100 according to the present embodiment includes: a wireless base station device 10-1; a wireless terminal device 20 that performs RF wireless communication with the wireless base station device 10-1 using an optical signal from the wireless base station device 10-1 for authentication; and a control device 40 that controls a plurality of the wireless base station devices 10-1.

A difference from the first embodiment is that a connection authentication control circuit 16-1 is provided in the control device 40 rather than in the wireless base station device 10-1.

The wireless base station device 10-1 includes: a base station-side optical ID correspondence list 11 containing an optical ID along with combined information including connection information and authentication information of wireless communication corresponding to the optical ID; an optical signal control circuit 12 that verifies the connection information and authentication information against the base station-side optical ID correspondence list 11, extracts a corresponding optical ID, and generates a signal pattern according to the extracted optical ID; an optical transmission circuit 13 that outputs the optical signal according to the signal pattern from the optical signal control circuit 12; a beam controller 14 that controls a beam shape of the optical signal from the optical transmission circuit 13 and delivers the optical signal into a space; and a base station-side RF receiver 15 that receives authentication information from the wireless terminal device 20 in predetermined RF wireless according to the connection information verified by the optical signal control circuit 12.

The wireless terminal device 20 is the same as in the first embodiment.

The control device 40 includes the connection authentication control circuit 16-1, which confirms a match between the authentication information from the base station-side RF receiver 15 and the authentication information verified by the optical signal control circuit 12, and permits information communication between a wireless terminal device 20 having matching authentication information and a higher-level network 30.

In a wireless communication method according to the present embodiment, the wireless base station device 10-1: verifies connection information and authentication information against the base station-side optical ID correspondence list 11 containing an optical ID along with combined information including connection information and authentication information of wireless communication corresponding to the optical ID; extracts a corresponding optical ID; generates a signal pattern according to the extracted optical ID; outputs an optical signal according to the generated signal pattern; and controls a beam shape of the output optical signal and delivers the optical signal into a space.

Next, the wireless terminal device 20: converts the optical signal from the wireless base station devices 10-1 into a signal pattern; regenerates an optical ID from the signal pattern that has been converted; verifies the optical ID against a terminal-side optical ID list containing an optical ID along with combined information including connection information and authentication information of wireless communication corresponding to the optical ID; extracts corresponding connection information and authentication information; and transmits the extracted authentication information in predetermined RF wireless according to the extracted connection information.

Furthermore, the wireless base station device 10-1 receives the authentication information from the wireless terminal device 20 in predetermined RF wireless according to the verified connection information.

Then, the control device 40: confirms a match between the received authentication information of the wireless base station device 10-1 and the authentication information verified against the base station-side optical ID correspondence list 11 of the wireless base station device 10-1; and permits information communication between a wireless terminal device 20 having matching authentication information and the higher-level network 30.

Operations of the wireless communication system will be described hereinafter with reference to FIG. 7.

The configuration and operations of the base station-side optical ID list 11, the optical signal control circuit 12, the optical transmission circuit 13, and the light beam controller 14 of the wireless base station device 10-1 are the same as in the first embodiment. The constituent elements of the wireless terminal device 20, and the operations thereof, are also the same as in the first embodiment.

The connection authentication control circuit 16-1 included in the control device 40 confirms whether the authentication information from the base station-side RF receiver 13 and the authentication information verified by the optical signal control circuit 12 match. When the two pieces of authentication information match, the connection authentication control circuit 16-1 permits the information communication between the wireless terminal device 20 and the higher-level network 30. Using an RF/optical wireless hybrid-type wireless communication system makes it possible to ensure the safety of communication. The wireless terminal device 20 may further include a terminal-side RF receiver, and the wireless base station device 10 a base station-side RF transmitter, for information communication following the authentication.

It is desirable that the optical ID analysis circuit 23 included in the wireless terminal device 20 perform the operations for analyzing the optical ID at the start of information communication. This is to ensure the safety of communication. This also makes it possible to perform stable information communication through RF wireless between the wireless base station device 10 and the wireless terminal device 20 even if the optical wireless is cut off after the analysis operations. The optical ID analysis circuit 23 may perform the determination operations periodically or continually. It is easy to ensure the safety of communication by blocking information communication when the wireless terminal device 20 moves outside the beam from the beam controller 14. The optical ID analysis circuit 23 may perform the determination operations within a pre-set timeslot, e.g., for only ten seconds. Limiting the time makes it easy to ensure the safety of communication.

A wireless communication system, wireless base station device, wireless terminal device, and wireless communication method according to the present embodiment make it possible to limit a communication area, ensure communication safety, and ensure communication stability by using the characteristics of optical wireless and RF wireless, and furthermore a wireless base station device, a wireless terminal device, and the like with a simple configuration. By having the connection authentication control circuit 16-1 control the plurality of wireless base station devices 10-1, it is possible to change the connection information for each wireless base station in a centrally-managed manner, to permit a specific wireless terminal device 20 to communicate information with the higher-level network only in a certain area in a centrally-managed manner, and so on.

Some of the devices in the present invention, e.g., the optical signal control circuit 12, the connection authentication control circuit 16, the connection authentication control circuit 16-1, and the optical ID analysis circuit 23, can also be realized by computer programs, and the computer program can be recorded onto a recording medium, provided over a network, and so on.

### INDUSTRIAL APPLICABILITY

The present disclosure can be applied in the information and communications industry.

### REFERENCE SIGNS LIST

10 Wireless base station device
10-1 Wireless base station device
11 Base station-side ID correspondence list
12 Optical signal control circuit
13 Optical transmission circuit
14 Beam controller
15 Base station-side RF receiver
16 Connection authentication control circuit
16-1 Connection authentication control circuit
20 Wireless terminal device
21 Optical receiver
22 Terminal-side optical ID correspondence list
23 Optical ID analysis circuit
24 Terminal-side RF transmitter
30 Higher-level network
40 Control device
100 Wireless communication system
101 Wireless communication system

1. A wireless communication system comprising:
a wireless base station device; and
a wireless terminal device that performs RF wireless communication with the wireless base station device using an optical signal from the wireless base station device for authentication,
wherein the wireless base station device includes:
a base station-side optical ID correspondence list containing an optical ID along with combined information including connection information and authentication information of wireless communication corresponding to the optical ID;
an optical signal control circuit that verifies the connection information and authentication information against the base station-side optical ID correspondence list, extracts a corresponding optical ID, and generates a signal pattern according to the extracted optical ID;
an optical transmission circuit that outputs the optical signal according to the signal pattern from the optical signal control circuit;
a beam controller that controls a beam shape of the optical signal from the optical transmission circuit and delivers the optical signal into a space;
a base station-side RF receiver that receives authentication information from the wireless terminal device in predetermined RF wireless according to the connection information verified by the optical signal control circuit; and
a connection authentication control circuit that confirms a match between the authentication information from the base station-side RF receiver and the authentication information verified by the optical signal control circuit, and permits information communication between a wireless terminal device having matching authentication information and a higher-level network, and
the wireless terminal device includes:
an optical receiver that receives the optical signal from the beam controller and converts the optical signal into a signal pattern;
a terminal-side optical ID list containing an optical ID along with combined information including connection information and authentication information of wireless communication corresponding to the optical ID;
an optical ID analysis circuit that regenerates an optical ID from the signal pattern from the optical receiver, verifies the optical ID against the terminal-side optical ID correspondence list, and extracts corresponding connection information and authentication information; and
a terminal-side RF transmitter that transmits the authentication information from the optical ID analysis circuit in predetermined RF wireless according to the connection information from the optical ID analysis circuit.

2. A wireless base station device that performs RF wireless communication with a wireless terminal device using an optical signal to the wireless terminal device for authentication, the wireless base station device comprising:
a base station-side optical ID correspondence list containing an optical ID along with combined information including connection information and authentication information of wireless communication corresponding to the optical ID;
an optical signal control circuit that verifies the connection information and authentication information against the base station-side optical ID correspondence list, extracts a corresponding optical ID, and generates a signal pattern according to the extracted optical ID;
an optical transmission circuit that outputs the optical signal according to the signal pattern from the optical signal control circuit;
a beam controller that controls a beam shape of the optical signal from the optical transmission circuit and delivers the optical signal into a space;
a base station-side RF receiver that receives authentication information from the wireless terminal device in predetermined RF wireless according to the connection information verified by the optical signal control circuit; and
a connection authentication control circuit that confirms a match between the authentication information from the base station-side RF receiver and the authentication information verified by the optical signal control circuit, and permits information communication between a wireless terminal device having matching authentication information and a higher-level network.

3. A wireless terminal device that performs RF wireless communication with a wireless base station device using an optical signal from the wireless base station device for authentication, the wireless terminal device comprising:
an optical receiver that receives the optical signal from the beam controller and converts the optical signal into a signal pattern;
a terminal-side optical ID list containing an optical ID along with combined information including connection information and authentication information of wireless communication corresponding to the optical ID;
an optical ID analysis circuit that regenerates an optical ID from the signal pattern from the wireless base station device, verifies the optical ID against the terminal-side optical ID correspondence list, and extracts corresponding connection information and authentication information; and
a terminal-side RF transmitter that transmits the authentication information from the optical ID analysis circuit in predetermined RF wireless according to the connection information from the optical ID analysis circuit.

4.-7. (canceled)
